(19) United States
(12) Patent Application Publication
(10) Pub. No.: US 2009/0292762 A1
(43) Pub. Date: Nov. 26, 2009

(54) Method, Apparatus, and Computer Program Product for Publishing Content

(75) Inventors: Hannu Mettala, Lapinkyla (FI); Toni Strandell, Helsinki (FI); Brenda Castro, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/123,761

(22) Filed: May 20, 2008

(51) Int. Cl. G06F 15/16

(52) U.S. Cl. 709/203

(57) ABSTRACT

An apparatus for publishing content may include a processor. The processor may be configured to receive a content item and receive a selection of user contact entries. Further, the processor may be configured to identify one or more online services associated with the selected user contact entries, and publish the content item on the one or more identified online services. Associated methods and computer program products may also be provided.

### TECHNICAL FIELD

Embodiments of the present invention relate generally to content sharing and, more particularly, relate to an apparatus, method and a computer program product for publishing content to be shared.

### BACKGROUND

As networking technologies continue to proliferate, innovators readily develop novel ways to access and share data. Recently, the sharing of digital photographs and other digital media has become popular among network users. In this regard, a user may capture media content (i.e., a photograph, video content, audio content, or the like) and publish the media content to an online service for sharing. Additionally, web services, email, RSS (Real Simple Syndication) feeds, music content, and even scanned paper photos may be shared using online services.

Online services are typically comprised of a network server that can receive uploaded content items from a user platform (e.g., a computer terminal connected to the network). Other users of the online service may log into the online service and access the content items that were published by other users.

Accessing these online services typically involves generating a user account with the online service. In this regard, the user account may be associated with a login name and a password. Users may enter the login name and password to gain access to the online service.

While online services provide a means for sharing content amongst many users, the services also have drawbacks. In particular, the popularity of online services for sharing content has caused creation of numerous online services. As such, many users may prefer one online service over another. Where two users prefer to use different services, content may not be shared between those users. While some users may be interested in content that is published with an online service the users do not prefer, these users may not have access to the content, with out creating an account with that online service.

In order for a user to have access to and view content on multiple services, the user typically must create an account with each online service. However, creating and managing a multitude of accounts for accessing content can be cumbersome and inefficient. Moreover, the complexity of creating and managing login names and passwords for a multitude of online services increases as a user associates herself with more users of different online services.

As such, it would be desirable to provide mechanisms for allowing content to be shared in a manner where each user may use a preferred online service to access the content. Moreover, it would be desirable to provide mechanisms that allow users to readily access content using a preferred online service, even though the content may not have been originally published to the online service.

### BRIEF SUMMARY

A method, apparatus, and computer program product are therefore described that provide for publishing content to online services. In this regard, exemplary embodiments of the present invention may receive a content item. In some exemplary embodiments, the content item may be received from an online service. In addition to receiving the content item, exemplary embodiments of the present invention may also receive a selection of user contact entries. The user contact entries may be determined from information stored in, for example, metadata associated with the content item. Further, one or more online services may be identified based on the information provided in the metadata. The online services may be identified based on an association between the online service and the selected user contact entries. The content item may be published to the identified online services. In this manner, in some exemplary embodiments, content published to a first online service by a first user may also be distributed to a second online service for access by a second user.

As such, exemplary embodiments of the present invention seamlessly share content items between online services allowing users to utilize a single online service for content sharing. In this regard, when a user of a first service uploads and publishes a content item to the first service, exemplary embodiments of the present invention receive the content item and distribute the content item to other online services. In this regard, some exemplary embodiments of the present invention may utilize application programming interfaces when interacting with the online services. Further, if response items (e.g., commentary) are published by users in association with the published content items, embodiments of the present invention may receive the response items and distribute the response items to the other online services where the content item was published.

In one exemplary embodiment, a method for publishing content is described. The method may include receiving a content item and receiving a selection of user contact entries. The exemplary method may further include identifying one or more online services associated with the selected user contact entries, and publishing the content item on the one or more identified online services.

In another exemplary embodiment, a computer program product for publishing content is described. The computer program product may include at least one computer-readable storage medium having computer-readable program code portions stored therein. The computer-readable program code portions may include a first program code portion, a second program code portion, a third program code portion, and a fourth program code portion. The first program code portion may be configured to receive a content item and the second program code portion may be configured to receive a selection of user contact entries. The third program code portion may be configured to identify one or more online services associated with the selected user contact entries and the fourth program code portion may be configured to publish the content item on the one or more identified online services.

In another exemplary embodiment, an apparatus for publishing content is described. The apparatus may include a processor. The processor may be configured to receive a content item and receive a selection of user contact entries. The processor may be further configured to identify one or more online services associated with the selected user contact entries and publish the content item on the one or more identified online services.

In yet another exemplary embodiment, a system for publishing content is described. The system may include a content sharing service, a first online service, a second online service, and a communications network. The content sharing service may have access to one or more user contact entries, where the user contact entries are stored with an association to an online service. Further, the first online service may include a content item and the second online service may be associated with a selected user contact entry. The communications network may provide for communications between the content sharing service, the first online service, and the second online service. Further, the content sharing service may be configured to receive the content item from the first online service and publish the content item on the second online service based on the association between the selected user contact entry and the second online service.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates an exemplary system of network entities according to exemplary embodiments of the present invention;

FIG. 3 illustrates a block diagram showing an apparatus for publishing content with associated network connectivity according to an exemplary embodiment of the present invention; and

FIGS. 4 and 5 are flowcharts according to exemplary methods for publishing content according to exemplary embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

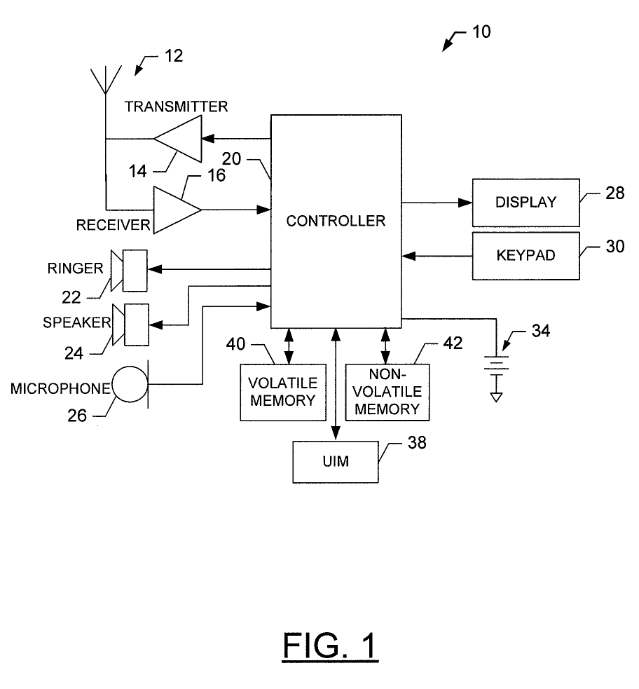

FIG. 1, one aspect of the invention, illustrates a block diagram of a mobile terminal 10 that would benefit from, and may be an exemplary apparatus of, embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the apparatus and method of embodiments of the present invention will be primarily described in conjunction with mobile communications applications. It should be understood, however, that the apparatus and method of embodiments of the present invention can be utilized in conjunction with a variety of other applications, both in the mobile communications industries and outside of the mobile communications industries.

The mobile terminal 10 may include an antenna 12 (or multiple antennas) in operable communication with a transmitter 14 and a receiver 16. The mobile terminal 10 may further include an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9 generation (3.9G) wireless communication protocols, such as Evolved Universal Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN), or other communication networks. Further, the mobile terminal 10 can communicate in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

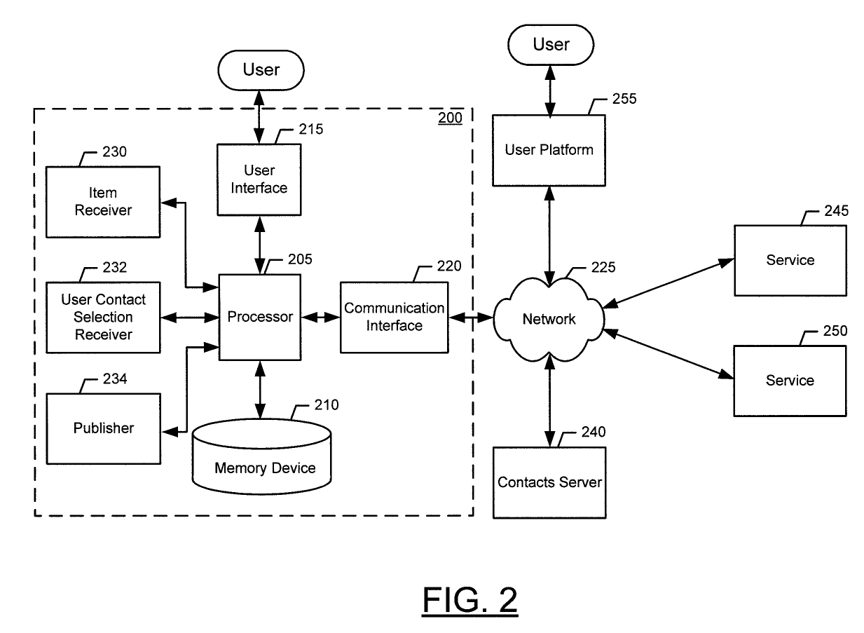

Referring now to FIG. 2, an exemplary apparatus 200 for publishing content is described. Apparatus 200 may be embodied as a server or other network device including, for example, a mobile terminal, such as mobile terminal 10 of FIG. 1. The apparatus 200 may include or otherwise be in communication with a processor 205, a user interface 215, a communication interface 220, and a memory device 210. The memory device 210 may include, for example, volatile and/or non-volatile memory (e.g., volatile memory 40 and/or non-volatile memory 42). The memory device 210 may be configured to store information, data, applications, instructions, or the like for enabling the apparatus to carry out various functions in accordance with exemplary embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information in the form of static and/or dynamic information, for example, in association with user contacts, invitations, member statuses, relationship groups, or the like.

The processor 205 may be embodied in a number of different ways. For example, the processor 205 may be embodied as a microprocessor, a coprocessor, a controller (e.g., controller 20 from FIG. 1), or various other processing means or elements including integrated circuits such as, for example, an ASIC (application specific integrated circuit) or FPGA (field programmable gate array). In an exemplary embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical, or other output to the user. As such, the user interface 215 may include, for example, a keyboard, a mouse, a joystick, a touch screen display, a conventional display, a microphone, a speaker, or other input/output mechanisms. In an exemplary embodiment in which the apparatus 200 is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver and/or supporting hardware or software for enabling communications with network 225, which may be any type of wired or wireless network. While network 225 may utilize a tiered structure, a peer-to-peer structure may also be implemented. Via the communication interface 220 and the network 225, the apparatus 200 may communicate with the contacts server 240, the service A 245, the service B 250, and/or the user platform 255.

The contacts server 240 may be any type of computing device for storing, retrieving, computing, transmitting, and receiving data. The contacts server 240 may include a memory device, a processor, and a communication interface for communicating with the network 225. In some embodiments, the contacts server 240 may be a web server, database server, file server, or the like.

According to various embodiments, the contacts server 240 may be a storage location for user contacts entries. User contact entries may data representations of an individual or entity. In some exemplary embodiments, user contact entries may be stored in association with contact information, such as, telephone numbers, email addresses, physical addresses, preferred online services, and the like. In this regard, a user may upload user contact entries to the contacts server 240 via, for example, network 225. In some exemplary embodiments, in addition to, or in lieu of, uploading user contact entries to the contacts server 240, user contact entries, and associated contact information (e.g., preferred online services), may be uploaded to the memory device 210. Further, user contacts entries associated with the user platform 255 may, for example, be uploaded to the contact server 240 via network 225. User contact entries may be received from the contacts server 240 or the memory device 210 by various network entities including apparatus 200. In some embodiments, the contact server 240 may be embodied by the memory device 210.

The user platform 255 may also be any type of device for storing, retrieving, computing, transmitting, and receiving data. In some embodiments, user platform 255 may be embodied as a mobile terminal 10 of FIG. 1, a computer that may implement a client web browser application, a computer that may implement a client application, or the like. User platform 255 may be representative of a plurality of user platforms, and as such any number of user platforms may be included in FIG. 2 connected to the network 225. In various embodiments, the user platform 255 may be used to access a content sharing service implemented by the apparatus 200. In this regard, the user platform 255 may access the apparatus 200 as a mobile terminal, a computer system using, for example, email, a web browser, or an application.

The services 245 and 250 may be any type of device for storing, retrieving, computing, transmitting, and receiving data, such as a server or the like. In this regard, the services 245 and 250 may be online services for sharing content amongst their respective users. For example, a user of the service 245 may upload content items to the service 245 to be published on the service 245. Accordingly, users of the service 245 may access content item via the service 245 to view or otherwise interact with the content item. In some exemplary embodiments, users of the services 245 or 250 may provide response items to be received by the services 245 or 250 and to be published by the services 245 or 250 in association with the content item. The response items may be provided in response to the publishing of a content item.

The item receiver 230, the user contact selection receiver 232, and the publisher 234 of apparatus 200 may be any means or device embodied in hardware, software, or a combination of hardware and software that is configured to carry out the functions of the item receiver 230, the user contact selection receiver 232, and the publisher 234, respectively, as described herein. In an exemplary embodiment, the processor 205 may include, or otherwise control the item receiver 230, the user contact selection receiver 232, and the publisher 234. In various exemplary embodiments, the item receiver 230, the user contact selection receiver 232, and the publisher 234 may reside on a server, or other network device including a mobile terminal, such as mobile terminal 10 of FIG. 1.

In some exemplary embodiments, the system of FIG. 2 may be utilized for synchronization of data amongst various network platforms. In this regard, the network platforms (i.e., the apparatus 200, the contacts server 240, the user platform 255, the services 245, 250, etc.) may be utilized by a user to access data. In some embodiments, the network platforms may be used to access data associated with an online service account for synchronization with other network platforms. Any type of data may be synchronized amongst the network platforms and made available for access by a user. Types of data may include user contact entries and associated contact information, content items (e.g., documents, photos, media content, etc.), response items, or the like. For example, user contact entries may be accessed and/or synchronized (i.e., updated) via the user platform 255, the contact server 240, or the apparatus 200. Upon modifying the user contact entries, the modified information, or more than the modified information, may be transmitted to a data storage device (e.g., the apparatus 200 or the contact server 240) or otherwise made available to the various network platforms for subsequent access.

In this manner, data modified on one network platform may be available to another network platform. For example, in some exemplary embodiments, the modified contact information may be automatically transmitted from the user platform 255 to the contact server 240 or the apparatus 200 for synchronization purposes. As such, the user may later access the modified contact information via user platform 255 and/or a browser.

In some embodiments, a user may set synchronization parameters, which may identify types of data that should be synchronized and types of data that need not be synchronized. For example, a user may set the synchronization parameters to synchronize the user contact entries, but may also set the synchronization parameters such that user profile information (i.e., personal information associated with the user) need not be synchronized. While the examples describe synchronization of data with respect to user contact entries, it is contemplated that any type of data may be synchronized between the network platforms in the same or a similar manner.

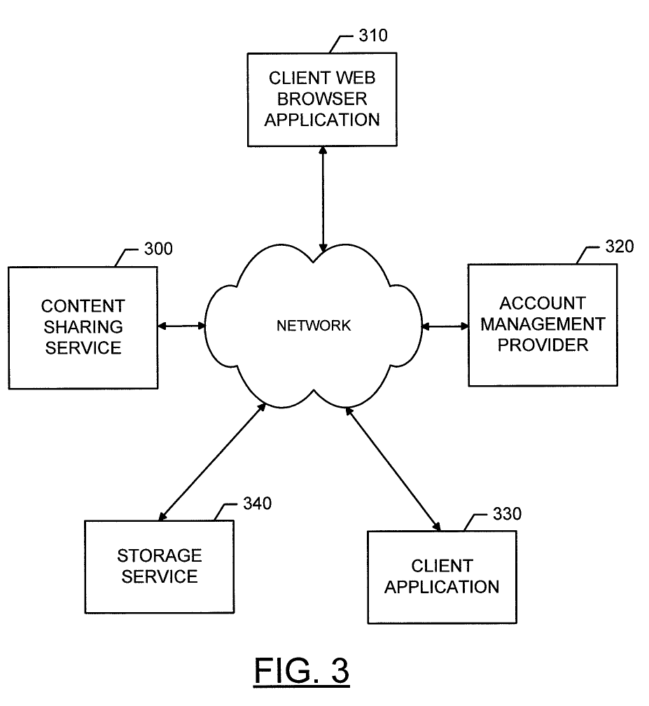

In this regard, and referring now to FIG. 3, an embodiment of a system in accordance with aspects of the present invention is illustrated. The system of FIG. 3 includes a content sharing service 300, a client web browser application 310, an account management provider 320, a client application 330, and a storage service 340. The content sharing service 300, the client web browser application 310, the account management provider 320, the client application 330, and the storage service 340 may be interconnected via the illustrated network, which may operate in the same manner as network 225.

The content sharing service 300, the account management provider 320, and the storage service 340 may collectively represent an embodiment of the apparatus 200 of FIG. 2. In this regard, the content sharing service 310 may represent an internet or network service based on a network server (e.g., a website, a social networking website, a blog website, a web feed, a widget, or the like) that may receive and interact with content items, response items, user contact entries and/or the like in a manner described with respect to the item receiver 230, the user contact selection receiver 232, the publisher 234, and the processor 205. Various types of data, such as, but not limited to, user contact entries, may be synchronized with and/or otherwise transferred to and from the content sharing service 300. The content sharing service 300 may utilize the storage service 340 for storage and retrieval of data by the content sharing service 300. In various embodiments, the storage service 340 may operate in the same manner as the memory device 210 and/or the contacts server 240. Further, the account management provider 320 may operate together with the various other network entities to perform account management and security features. In some embodiments, login information and passwords are first directed to the account management provider 320 for verification. Upon verification, the account management provider 320 may provide access to, and allow communications between, various network entities using, for example, a token or other access key.

Client application 330 may be a software or hardware application residing and operating on a platform, such as a computer, mobile terminal, or the like, that may be used to interact with the content sharing service 300. In some embodiments, the client application 330 may reside and operate on the apparatus 200, the user platform 255, or the like, and may operate in the same manner as apparatus 200, the user platform 255, or the like. The client application may be downloaded to and/or installed on the platform. In some embodiments, the client application 330 may be specifically tailored to interact with the content sharing service 300. Via the client application 330, the platform, and the user of the platform, may interact with the content sharing service 300 to send and receive data, such as user contact entries, between the client application 330 and the content sharing service 300. The client application 330 may facilitate the gathering and storage of usage attributes for subsequent transmission to the content sharing service 300.

Similar to the client application 330, the client web browser application 310 may be a software or hardware application residing and operating on a platform, such as a computer, mobile terminal, or the like, that may be used to interact with the content sharing service 300. In this regard, the client web browser application 310 may be a generic network communication application for interacting with various network platforms, including the content sharing service 300. In some embodiments, the client web browser application 310 may reside and operate on the apparatus 200, the user platform 255, or the like, and may operate in the same manner as the apparatus 200, the user platform 255, or the like. Via the client web browser application 310, the associated platform, and the user of the platform, may interact with the content sharing service 300 to send and receive, as well as synchronize, data, such as user contact entries, content items, response items, or the like between the client web browser application 310 and the content sharing service 300. The client web browser application 310 may facilitate the gathering and storage of usage attributes for subsequent transmission to the content sharing service 300.

Referring back to FIG. 2, the item receiver 230 may be configured to receive a content item. In this regard, the apparatus 200 may include various means for receiving a content item, which may include the processor 205, the item receiver 230, the user interface 215, algorithms for receiving a content item described herein and executed by the foregoing or other elements, and/or the like. According to various exemplary embodiments of the present invention, a content item may be a media item (e.g., a photograph, a video, an audio object, etc.), text (e.g., blog entries, bulletin board entries, etc.), documents, any other type of content, or the like.

In this regard, a user may create an account with, or otherwise subscribe to, a content sharing service implemented by the apparatus 200. As such, a user may create an account with the content sharing service and indicate a preferred online service for publishing content. The account may include a profile, and the profile may include contact information, a list of user contact entries directed to the user, a unique identifier, a preferred online service, addresses for the service, usernames and/or passwords for the online services, preferences and rules for publishing content items, and notification settings. In some embodiments, the user's preferred online service may be the content sharing service implemented by the apparatus 200 or another online service, such as the services 245, 250. In exemplary embodiments where the content sharing service implemented by apparatus 200 is the user's preferred online service, the content item may be received by the item receiver 230 from the user interface 215, the user platform 255, or the like. In this regard, the user platform 255 may be embodied as, for example, a device including stored content items (e.g., a digital camera with stored photos). In some exemplary embodiments, a user may generate an account with a preferred online service and the content sharing service to share content items across multiple online services.

In some exemplary embodiments, the content item may be uploaded to and published to the user's preferred online service, such as, for example, the service 245, prior to being received by the item receiver 230. In this regard, for the item receiver 230 to receive the content item, the online service may push the content item, or a notification of a content item publishing event, to the item receiver 230 when the online service publishes the content item. In this regard, a content item publishing event may be the occurrence of a content item being published (i.e., made available for user inspection). In various embodiments of the present invention, a content item publishing event may occur when the user uploads the content item to an online service, or when the user adds particular tags (e.g., sharing tags), metadata, or the like to the content item.

As such, the content publishing event may indicate that a content item has been published to an online service. In some exemplary embodiments, in response to a content item publishing event, the content item may be pushed to the item receiver 230 by the publishing online service. Accordingly, the content item may be received as the content item is pushed by the online service to the item receiver 230.

In some exemplary embodiments where pushing of the content item is utilized, the online service, such as service 245, may implement the push operation in combination with the use of a user interface. In this regard, the online service may provide a user interface for capturing data associated with the content items. For example, via the user interface, a user may specify entities that may have access to the content item.

In other embodiments, the content item receiver may be configured to monitor an online service, such the user's preferred online service, for a content item publishing event. In this regard, the item receiver 230 may be configured to poll the online service to determine when a content item publishing event occurs. In some exemplary embodiments, the item receiver may monitor the activities of users of the content sharing service. When the item receiver 230 detects a content item publishing event, the content item may be requested from the online service and received by the item receiver 230. Further, in some exemplary embodiments, polling of content item publishing events may be implemented in combination with pushing content items as described above. In this manner, for example, legacy systems may utilize polling, while advanced online services may provide a content item via an exemplary pushing solution.

In some embodiments, the item receiver 230 may also be configured to receive additional data associated with the content item indicating publishing rules or preferences. In some embodiments, the additional data may be received as one or more tags associated with the user contact entries. In this regard, when a user uploads a content item to an online service, including the apparatus 200, the user may input additional data with content item in the form of one or more tags. The tags may be data, such as metadata, associated with the content item. The tags may include publishing preferences or rules provided by the user indicating how the content item is to be published. For example, a user may provide information in the tags indicating which user contact entries may be given access to the content item. Further, the tags may include user defined publishing rules indicating, for example, the online services that the content item may be published to, and when the content item may be published to the online services (e.g., publish the content item to a first service during the day and publish the content item to another service at night). In some embodiments, a title field associated with a content item may be used to include data associated with the content item, such as, the name of the author of the content item.

In some embodiments, EXIF (exchangeable image file format) metadata may be used in addition to, or in lieu of, tags. The EXIF metadata may be user specified and associated with the content item. The EXIF metadata may operate in the same manner as described with respect to the tags. A dedicated client or any generic software may be used to set the EXIF metadata. With regard to the type of data, for example, selected user contact entries may be included in the EXIF metadata. In some embodiments, EXIF metadata may not be presented to user of an online service (i.e., the EXIF metadata may reside in the background). Further, in some embodiments where the content item embodied as a data file, the data file may be modified to include the EXIF metadata.

In various embodiments, the item receiver 230 and/or the processor 205 may interact with an online service using an API (application programming interface) to perform various operations between the apparatus 200 and one or more online services, such as services 245, 250. An API may be a programming language structure including predefined commands for interacting with one or more online services. In some embodiments, the API may be a public API. A public API may be a type of API that is available for use outside of the online service environment and acts upon the online service, as apposed to an API that may only be used within the online service. Similarly, in some exemplary embodiments, an ATOM syndication format and an ATOM Publishing Protocol (APP) may also be utilized in association with various aspects of the present invention.

With regard to the use of the API, the processor 205 of apparatus 200 may use the API to, for example, monitor an online service for an content item publishing event. In this regard, commands provided in the API may allow for polling of the online services to detect a newly published content item uploaded by a selected user.

The user contact selection receiver 232 may be configured to receive a selection of user contact entries. In this regard, the apparatus 200 may include various means for receiving a selection of user contact entries, which may include the processor 205, the user contact selection receiver 232, the user interface 115, algorithms for receiving a selection of user contact entries described herein and executed by the foregoing or other elements, and/or the like. The selection of user contact entries may indicate which individuals or entities to notify and/or provided access to the published content item. In this regard, the user contact entries may be indications of individuals or entities that a user may have a relationship with, such as, friends, family, business associates, etc. User contact entities may be selected one entity at a time or groupings of user contact entries may be utilized. In some exemplary embodiments, a private group may be generated for sharing content items only within the group.

The selection of user contact entries may occur at the time a user uploads a content item to an online service. A user may select particular user contact entries as a means of granting access to the selected user contacts. In some exemplary embodiments, selection of user contact entries may also provide the user contacts with a notification that the content item has be published.

The selections of user contact entries may be made from a list of user contacts residing on, for example, the user platform 255, the contacts server 240, or the like. In some exemplary embodiments, the user contact entries may be imported from a mobile terminal for later selection. The selection of user contact entries may be input into tags, EXIF metadata, a title field, hypertext transfer protocol (HTTP) objects, or the like that are associated with the content item. When the content item is received, with the selection of user contact entries, the user contact selection receiver 232 may analyze the tags, EXIF metadata, a title field, hypertext transfer protocol (HTTP) objects, or the like to extract and receive the selected user contact entries.

Additionally, subsequent to receiving the selected user contact entries, the user contact selection receiver 232 may also be configured to identify one or more online services associated with the selected user contact entries. In this regard, the apparatus 200 may include various means for identifying one or more services, which may include the processor 205, the user contact selection receiver 232, algorithms for identifying one or more services described herein and executed by the foregoing or other elements, and/or the like. Further, each user contact entry may be associated with an online service, which may be stored as online service preference information. For example, when a user generates an account with the content sharing service of apparatus 200, the user may specify a preferred online service that may be stored in association with the user. Further, in some exemplary embodiments, a user may specify another user's preferred online service when adding the other user to a contact list on, for example, a mobile terminal. Additionally, in some exemplary embodiments, the entity identified as the receiver may input a preferred service when they are notified of shared content items.

In some exemplary embodiments, each user may not be associated with a preferred online service. In this regard, communications, such as emails, may be sent to the user without associated preferred online services in an attempt to have the users identify a preferred online service (e.g., through a registration process), and thus enable sharing of the content item.

In this regard, the online service preference information may be shared amongst various users of the content sharing service implemented by apparatus 200. For example, if user 1 enters a new contact entry for user 2 and indicates that user 2 prefers the service 245, this information may be stored in the user platform 255, the contacts server 240, the memory device 210, or the like. The information indicating that user 2 prefers the service 245 may be made available such that if a user 3 desires to publish a content item and grant access to the content item to user 2, processor 205 within apparatus 200 may utilize the online service preference information input by user 1 to determine user 2's preferred online service. In some exemplary embodiments, each user contact entry may be associated with a unique identifier. The unique identifier may be used to match or link user contact entries from various sources. In this manner, online service preference information may be shared amongst various users. In some exemplary embodiments, the unique identifier may be a phone number or an email address.

The publisher 234 may be configured to publish the content item on the one or more identified online services. In this regard, the apparatus 200 may include various means for publishing the content item, which may include the processor 205, the publisher 234, algorithms for publishing the content item described herein and executed by the foregoing or other elements, and/or the like.

After identifying the preferred online services of the selected user contact entries, the content item may be published to the online services that are preferred by the selected user contact entries. In this regard, in some embodiments, the content item may be published via an API, or a public API, associated with the identified online service. Publishing the content item on the online services may include providing commands indicating which users of the online service may be granted access to the content item. Such commands may be generated based on the information provided in the tags, the EXIF metadata, the HTTP objects, any other data provided with the content item, or the like. In this regard, the content item may be published to the identified online services based on the publishing rules or preferences that may be specified during the initial uploading of the content item to an online service and propagated to other online services. In some exemplary embodiments, the tags, metadata, or the like may be already associated with the content item in another source, service, or device.

According to various exemplary embodiments of the present invention, publishing a content item to an online service may include providing the online service with an address indicating where the content item is stored. In this regard, the content item need not be stored on a server associated with an online service, but rather the content item may be stored in, for example, memory device 210, and a link to the content item may be provided to the online service where the content item is to be published.

In some embodiments, the item receiver 230 may be configured to receive a response item. In this regard, the apparatus 200 may include various means for receiving a response item, which may include the processor 205, the item receiver 230, the user interface 215, algorithms for receiving a response item described herein and executed by the foregoing or other elements, and/or the like. The response item may be any data that is provided in association with the published content item, or is otherwise associated with the content item. The response item may be provided in response to the publishing of the content item. For example, if the content item is a photo, then the response item may be textual commentary regarding the photograph. In some embodiments, only entities having access to the content item may also have access to submit a response item or be presented a response item. Further, additional information, such as tags and other metadata associated with the response item, may be received with the response item.

In some embodiments, publishing of the content item may result in the content item be located on multiple online services. As a result, a response item may be received from a first online service. Exemplary embodiments of the present invention may distribute the response item to the other identified online services where the content item was published. In this regard, a user may provide a response item to an online service in association with a published content item on the same service. The online service may then provide the response item to the item receiver 230.

In some exemplary embodiments, the response item may be provided to and published by a user's preferred online service, such as, for example, the service 245. The publishing of the response item in association with the content item may constitute a response item publishing event. As such, in some exemplary embodiments, the online service may push the response item, or a notification of the response item publishing event, to the item receiver 230 when a response service publishing event occurs. As such, the response item may be received as the response item is pushed by the online service to the item receiver 230.

In other embodiments, the item receiver 230 may be configured to monitor one or more online services where the content item is published for a response item publishing event. In this regard, the item receiver 230 may be configured to poll the online services to determine when a response item publishing event occurs. For example, when a user of an online service publishes a comment to a content item, the item receiver may detect a response item publishing event. When the item receiver 230 detects a response item publishing event, the response item may be requested from the online service and received by the item receiver 230. Further, in some exemplary embodiments, polling for response item publishing events may be implemented in combination with pushing response items as described above. In this manner, for example, legacy systems may utilize polling while advanced online services may provide a response item pushing solution.

Online services, including the content sharing service, may provide a user interface to users for adding response items to a content item. In some instances, however, HTTP may be used to add response items to content items.

With respect to response items, publisher 234 may be configured to publish the response item to a second identified online service in association with the content item. In this regard, the apparatus 200 may include various means for publishing the response item, which may include the processor 105, the publisher 234, the user interface 215, algorithms for publishing the response item described herein and executed by the foregoing or other elements, and/or the like. Accordingly, when a response item is published to a first online service by a user in association with the content item, the apparatus 200 may re-publish the response item to all other online services that were identified when preparing to publish the content item. In this manner, a response item with respect to the same content item may be provided across a multitude of identified online services. As described above, an API or a public API may be used to publish the response item to associated online services.

According to various exemplary embodiments of the present invention, the processor 205 may be configured to allow users of the content sharing service to interact with aggregated content items and response items. In this regard, in some exemplary embodiments, all of the content items published by a user and the associated response item may be stored on the memory device 210 or an external storage. As such, a user may access the content items and the associated response items directly from the apparatus 200, via, for example, the user platform 255 and the network 225. In a similar regard, the apparatus 200 may be accessed via an API which may be a public API.

Some example scenarios will now be provided that describe the implementation of various aspects of the present invention. In this regard, assume two friends Jill and John use the service 245 and the content sharing service described with respect to apparatus 200. The scenarios are directed to sharing content items that are photos, but it is contemplated that the scenarios are equally applicable to any type of content item.

In a first scenario, John wants to share images with Jill. As a result, online service preference information and a username for the preferred online service may be input in association with a user contact entry directed to Jill. In this scenario, Jill's preferred online service is service 245. In some exemplary embodiments, if Jill's online service preference information is unknown, and the content sharing service cannot locate a match for Jill in the user contact entries stored in association with the content sharing service, Jill may receive an invitation via email, simple message service (SMS), or the like requesting that she add her online service preference, as well as other information, to the content sharing service. In this regard, the invitation may contain an address (e.g., a URL (uniform resource locator)) to a page in the content sharing service where Jill may add her online service preference and other information.

Upon providing her online service preference information, Jill may be redirected to service 245's web page. An example URL for redirection may be

http://service_245.com/services/auth/?api_key=
[Serviceapi_key]&perms=write&api_sig=[signature]

Upon presentation of the web page, Jill may authorize the content sharing service to access her content items (e.g., photos, including private photos), edit her photo information, and upload photos to her service 245 account.

As such, the content sharing service may register a callback URL redirecting Jill to finalize preference registration. The content sharing service may also create an entry for Jill and store her usernames and other necessary information. As a result, Jill's information, including her online service preference, may now be automatically accessible to the content sharing service whenever anyone having a user contact entry directed to Jill decides to share a content item with Jill.

In this regard, authorization to use Jill's information may be valid indefinitely, unless she revokes it. If authorization is revoked or expired for some other reason, the content sharing service may send a new authorization URL to Jill by email or the like for reauthorization. Jill may also unregister at any time on the content sharing service's web page.

As an alternative to authorizing the content sharing service to access Jill's content items, a private group within the service 245 may be created that is dedicated for sharing purposes only. Both the content sharing service and Jill may have access to the content items in the group and the group may be used to share images to Jill by any user of the content sharing service and to receive her response items.

In this scenario, John wants to share an image with Jill. As such, he may launch an application on his mobile terminal or otherwise log-in to the content sharing service's web user interface. John may then select an image to share and select the user contact entry associated with Jill. The image may then be sent to the content sharing service using, for example, the content sharing service API with a targets tag set as Jill. The targets tag may be stored with the image. The content sharing service implemented on apparatus 200 may receive the image, and identify Jill's online service preference from the stored information.

The image may then be uploaded to service 245, using a service 245 photo upload API. For example, an upload commend with an exemplary API may be “http://api.service_245.com/services/upload/” and arguments associated with the photo upload API may include a photo field for indicating the name of the file to upload, a title field for including the title of the photo, a description field for describing the photo, an is_public field for specifying whether the photo is public or private, a content_type field for describing the type of content the file includes (e.g., photo), and a hidden field for specifying whether the photo is hidden from public searches. The photo upload API may also include a tags field that may include a space-separated list of tags to apply to the photo including the tags added by the content sharing service to specify that the photo is shared to Jill. In this regard, the tags field may also include “author John” to indicate that the image is shared to Jill by John.

The image may then be added by the content sharing service to Jill's photo stream on the service 245. Jill may notice the new shared image in the service 245 and click the image thumbnail to view a larger size image and details of the image. In some exemplary embodiments, if the image was set as public, Jill could also use a web feed to receive notification of her latest public images. However, by setting the image to public, the image would also be visible to anyone. The content sharing service may also send a notification of the published image to Jill via email if she has requested such a notification in her content sharing service profile. In some embodiments, the content sharing service may record an image photo identifier that may be used to access the photo later, during, for example, polling for a response item publishing event.

In a second scenario, Jill may wish to share an image with John. In this regard, Jill may need to be a registered user of the content sharing service to share her images. Jill's user contact entries, including a user contact entry directed to John, may be synchronized from Jill's mobile terminal with Jill's user contact entries in the content sharing service. Jill may share any of her private or public images to John using her preferred service (i.e., service 245 in this scenario). Jill may add tags for “share” and “target John” to the image. If Jill wants to share the image to other user contact entries or groups in the content sharing service, Jill may add more “target [contact_name_in_content_sharing_service]” or “target [group_name_in_content_sharing_service]” tags to the image.

In this regard, the content sharing service may monitor Jill's images in the service 245 for newly published images using, for example, an API associated with the service 245. For example, the API command may be “service_245.photos.recentlyUpdated” and arguments associated with this command may include a min_date field for indicating the last checking time. A response from the command may contain the identifiers of the recently updated photos. Information about a photo may also be obtained using an API associated with the service 245. For example, the command may be “service_245.photos.getInfo” and arguments associated with this command may include a photo_id field for indicating the identifier of the photo. The response to this command may contain the URL and the tags associated with the photo.

The content sharing service may monitor all Jill's images for changes (and all other registered content sharing service users' images) and may verify if any of the images have the tags “share” and/or “target [contact].” In this scenario Jill publishes a photo to the service 245 with a share tag and a target tag of “John.” The target corresponds to a user contact entry of John in Jill's user contact entries in the content sharing service.

As such, the content sharing service may retrieve John's profile and determine that he uses the content sharing service as his preferred online service. The content sharing service may then download the image from the service 245 and publish the image to the content sharing service. In this regard, publishing the image may include pushing the image to John's mobile terminal using the API of the content sharing service. John may see the notification regarding the image on his mobile terminal and immediately browse the image.

Alternatively, John can use the content sharing service's web user interface to view the image. John may also notice that Jill is the author of the image as indicated by the title of the image. In some exemplary embodiments, the content sharing service may change the tag “share” to “shared” in the original image in service 245 using the service 245 API. An example command may be “service 245.photos.removeTag” and arguments may include a tag_id field for identifying the tag to be removed. In this case, the tag_id field may indicate the share tag. Subsequently, an API command for adding a tag may be used, such as “sevice_245.photos.addTags” that may include arguments such as, a photo_id field for identifying the photo and a tag “shared” field for adding tags. The content sharing service may also record the image's photo identifier for later use, such as if John adds comments (i.e., response items) to the image.

Alternatively, if John used some other online service (e.g., the service 250) as his preferred online service, the content sharing service may upload and publish the image to the service. The content sharing service may also add the shared tag and the “author Jill” tag to the image.

In a third scenario, John comments on an image shared with him by Jill. In this regard, John wants to comment on an image that Jill has shared with him. As such, John launches a client application on his mobile terminal or visits the content sharing service's web user interface. John then selects Jill's image and adds his comment (i.e., response item).

John's comment may be sent to the content sharing service using the content sharing service API, with the image identifier. The content sharing service may locate the image identifier in, for example, memory device 210, and determine that the image is also associated with the service 245. The comment may then be sent to the servie 245 using an API command, such as “service_245.photos.comments.addComment” including arguments such as, a photo_id field for indicating the identifier of the photo, and a comment_text field for indicating the comment text (e.g., “John: This image is just marvellous!”). In some exemplary embodiments, the content sharing service may add the author of the comment to the comment_text field to identify the author.

The comment may be added to the image in service 245, and Jill may see the comment via a service 245 web user interface. Jill may also see that John is the author of the comment.

If the image is not private, Jill may also subscribe to receive recent activity on her photos feed from service 245. In this regard, Jill may check the feed and notice that she has received a new comment to her image. She may click the image thumbnail and be taken to the web page of the image to see the comment.

In this regard, the content sharing service may maintain a mapping of the original content item and its shared replicas in other services. As such, whenever a response item is published to any one of the content items, the response items may be forwarded to the other online services where the content item resides. Further, if public content items are shared, response items to the public content items may be forwarded in addition to response items generated by selected user contact entries.

In a fourth scenario, Jill wishes to comment on an image shared with her by John. When Jill wants to add comments to an image that John has shared with her, she may select the image in the service 245 web page and add her comments to the image, as with any other image in service 245. The content sharing service may monitor all images that the content sharing service has uploaded for any changes, such as changes indicating that the images have received new comments. The content sharing service may use the service 245 API to monitor for changes. The command may be “service 245.photos.recentlyUpdated” and associated arguments may include a min_date field indicating the last time the photo was checked. A response to this command may include the identifiers of the recently updated photos.

Information about the photos may be obtained using the service 245 API command “service_245.photos.getInfo,” which may include a field photo_id for indicating the photo identifier. A response to this command may include the tags of the photo. The content sharing service may verify if any of the updated images have the tags “share” or “shared,” and “author [contact]” or “target [contact].” The content sharing service may also verify that the identified contact has a user contact entry in the content sharing service.

The comments for the image may be received using the service 245 API command “service_245.photos.comments.getList” with arguments that may include a photo_id field indicating the identifier of the photo. The response to this command may include the comment text, the authors, and time stamps of the photo. The content sharing service may find any new comments that have been added after the last checking time. The content sharing service may then retrieve John's profile and determine that John uses the content sharing service as his preferred online service. The content sharing service may then locate the mapping from the image identifier in the service 245 to the image identifier of the original image in the content sharing service.

The content sharing service may add the comment text, and the author, to the image that is stored in the content sharing service. Additionally, the content sharing service may notify John of new comments added to John's images. For example, a popup window may appear on the display of John's mobile terminal indicating that the comment has been added. John may select a show button and a client application running on John's mobile terminal may be brought to the foreground of the display. The client application may fetch the image and its comments using the content sharing service API and show the image and the comments on the display. Alternatively, if John used some other online service (e.g., the service 250) as his preferred online service, the content sharing service may upload and publish the comment to the service.

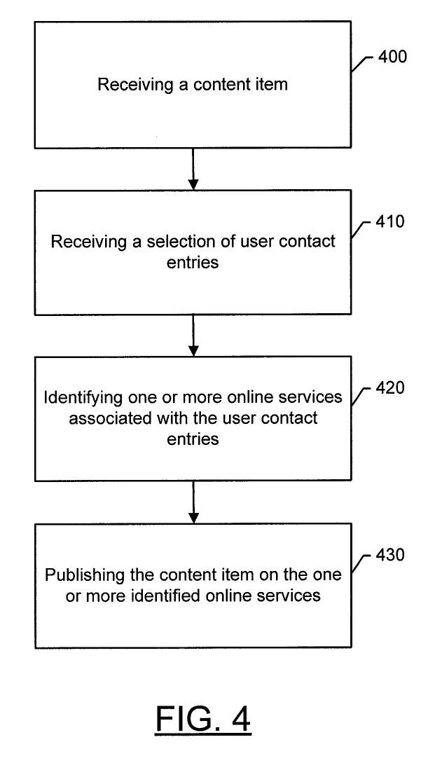

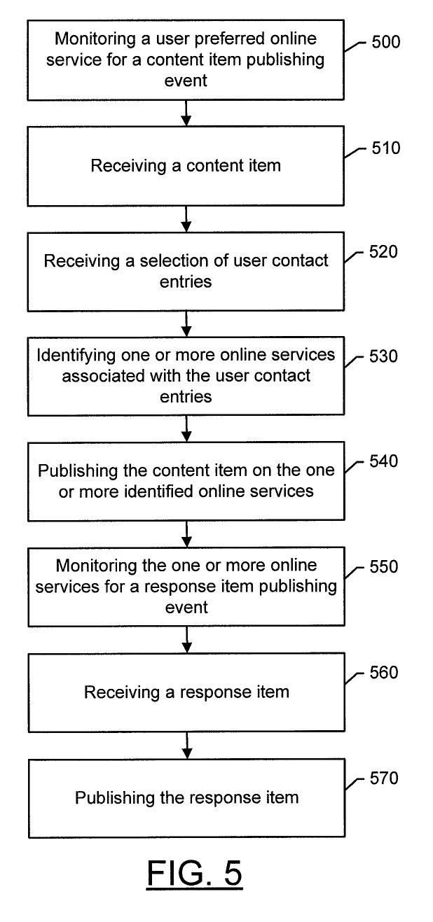

FIGS. 4 and 5 are flowcharts of a system, method, and program product according to exemplary embodiments of the invention. It will be understood that each block, step, or operation of the flowcharts, and combinations of blocks, steps or operations in the flowcharts, can be implemented by various means, such as hardware, firmware, and/or software including one or more computer program code portions, program instructions, or executable program code portions. For example, one or more of the procedures described above may be embodied by computer program code instructions. In this regard, the computer program instructions which embody the procedures described above may be stored by a memory device of the apparatus and executed by a processor in the apparatus. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s), step(s), or operation(s). These computer program instructions may also be stored in a computer-readable memory that can direct a computer, a processor, or other programmable apparatus to function in a particular manner, such that the instructions stored in the computer-readable memory produce an article of manufacture including instruction means which implement the function specified in the flowcharts block(s), step(s), or operation(s). The computer program instructions may also be loaded onto a computer, processor, or other programmable apparatus to cause a series of operational steps to be performed on the computer, processor, or other programmable apparatus to produce a computer-implemented process such that the instructions which execute on the computer, processor, or other programmable apparatus provide steps for implementing the functions specified in the flowcharts block(s), step(s), or operation(s).

Accordingly, blocks, steps, or operations of the flowcharts support combinations of means for performing the specified functions, combinations of steps for performing the specified functions and program instruction means for performing the specified functions. It will also be understood that one or more blocks, steps, or operations of the flowcharts, and combinations of blocks, steps, or operations in the flowcharts, can be implemented by special purpose hardware-based computer systems which perform the specified functions or steps, or combinations of special purpose hardware and computer instructions.

In this regard, one exemplary embodiment of a method for publishing content as illustrated in FIG. 4 may include receiving a content item at 400. In this regard, in some embodiments, receiving the content item may include monitoring a user preferred online service for a content item publishing event. The content item publishing event may indicate that the content item has been published to the user preferred online service. Receiving the content item may also include receiving the contact item from the user preferred online service. Further, receiving the content item may also include receiving one or more tags associated with the content item. In some embodiments, receiving the content item may also include receiving an upload from a mobile device, such as, a digital camera.

The exemplary method may also include receiving a selection of user contact entries at 410. In some exemplary embodiments, receiving the selection of user contact entries may include determining the selection of user contact entries from the one or more tags. Further, in some exemplary embodiments, receiving the selection of user contact entries may include receiving the selection of user contact entries where the user contract entries are imported from a mobile terminal.

Additionally, the exemplary method may include identifying one or more online services associated with the selected user contact entries at 420. In this regard, in some exemplary embodiments, online service preference information may be stored in association with each user contact entry such that the online service preference information may be shared.

The exemplary method may also include publishing the content item on the one or more identified online services at 430. In some exemplary embodiments, the content item may be published via an API, where each online service may be associated with an API. Further, in some exemplary embodiments, the content item may be published based on publishing rules.

Another exemplary embodiment of a method for publishing content as illustrated in FIG. 5 may include monitoring a user preferred online service for a content item publishing event at 500. The content item publishing event may indicate that the content item has been published to the user preferred online service. Further, the exemplary method may include receiving the content item at 510 and receiving a selection of user contact entries at 520. At 530, the exemplary method may also include identifying one or more online services associated with the selected user contact entries, and at 540 the method may include publishing the content item on the one or more identified online services.

The exemplary method may further include monitoring one or more online services for a response item publishing event at 550. In this regard, the response item publishing event may indicate that the response item has been published to at least one of the one or more online services. At 560, the exemplary method may include receiving a response item from a first identified online service. In this regard, the response item may be associated with the content item. The exemplary method may further include publishing the response item to a second identified online service in association with the content item at 570.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a content item;
receiving a selection of user contact entries;
identifying one or more online services associated with the selected user contact entries; and
publishing the content item on the one or more identified online services.

2. The method of claim 1, wherein publishing the content item includes publishing the content item via an application programming interface (API), each online service having an associated API.

3. The method of claim 1, further comprising:
receiving a response item from a first identified online service, the response item being associated with the content item; and
publishing the response item to a second identified online service in association with the content item.

4. The method of claim 3 further comprising:
monitoring the one or more online services for a response item publishing event, the response item publishing event indicating that the response item has been published to at least one of the one or more online services.

5. The method of claim 3, wherein publishing the response item includes publishing the response item via an application programming interface (API) associated with the second identified online service.

6. The method of claim 1, wherein receiving the content item includes:
monitoring a user preferred online service for a content item publishing event, the content item publishing event indicating that the content item has been published to the user preferred online service; and
receiving the content item from the user preferred online service.

7. The method of claim 1, wherein receiving the content item includes receiving metadata associated with the content item, and wherein receiving the selection of user contact entries includes determining the selection of user contact entries from the metadata.

8. The method of claim 1, wherein publishing the content item includes publishing the content item based on publishing rules.

9. The method of claim 1, wherein receiving the selection of user contact entries includes receiving the selection of user contact entries, the user contract entries being imported from a mobile terminal.

10. The method of claim 1, wherein identifying the one or more online services associated with the selected user contact entries includes identifying the one or more online services, wherein online service preference information is stored in association with each user contact entry such that the online service preference information is shared.

11. An apparatus comprising a processor, the processor configured to:
receive a content item;
receive a selection of user contact entries;
identify one or more online services associated with the selected user contact entries; and
publish the content item on the one or more identified online services.

12. The apparatus of claim 11, wherein the processor being configured to publish the content item includes being configured to publish the content item via an application programming interface (API), each online service having an associated API.

13. The apparatus of claim 11, the processor further configured to:
receive a response item from a first identified online service, the response item being associated with the content item; and
publish the response item to a second identified online service in association with the content item.

14. The apparatus of claim 13, the processor further configured to:
monitor the one or more online services for a response item publishing event, the response item publishing event indicating that the response item has been published to at least one of the one or more online services.

15. The apparatus of claim 13, wherein the processor being configured to publish the response item includes being configured to publish the response item via an application programming interface (API) associated with the second identified online service.

16. The apparatus of claim 11, wherein the processor being configured to receive the content item includes being configured to:
monitor a user preferred online service for a content item publishing event, the content item publishing event indicating that the content item has been published to the user preferred online service; and
receive the content item from the user preferred online service.

17. The apparatus of claim 11, wherein the processor configured to receive the content item includes being configured to receive metadata associated with the content item, and wherein the processor configured to receive the selection of user contact entries includes being configured to determine the selection of user contact entries from the metadata.

18. The apparatus of claim 11, wherein the processor configured to publish the content item includes being configured to publish the content item based on publishing rules.

19. The apparatus of claim 11, wherein the processor configured to receive the selection of user contact entries includes being configured to receive the selection of user contact entries, the user contract entries being imported from a mobile terminal.

20. The apparatus of claim 11, wherein the processor configured to identify the one or more online services associated with the selected user contact entries includes being configured to identify the one or more online services, wherein information describing the online services is stored in association with each user contact entry such that the information is shared.

21. A computer program product comprising at least one computer-readable storage medium having executable computer-readable program code portions stored therein, the computer-readable program code portions comprising:
a first program code portion configured to receive a content item;
a second program code portion configured to receive a selection of user contact entries;
a third program code portion configured to identify one or more online services associated with the selected user contact entries; and
a fourth program code portion configured to publish the content item on the one or more identified online services.

22. The computer program product of claim 21, wherein the fourth program code portion being configured to publish the content item includes being configured to publish the content item via an application programming interface (API), each online service having an associated API.

23. The computer program product of claim 21, wherein the computer-readable program code portions further comprise:
a fifth program code portion configured to receive a response item from a first identified online service, the response item being associated with the content item; and
a sixth program code portion configured to publish the response item to a second identified online service in association with the content item.

24. The computer program product of claim 23, wherein the computer-readable program code portions further comprise:
a seventh program code portion configured to monitor the one or more online services for a response item publishing event, the response item publishing event indicating that the response item has been published to at least one of the one or more online services.

25. The computer program product of claim 23, wherein the sixth program code portion being configured to publish the response item includes being configured to publish the response item via an application programming interface (API) associated with the second identified online service.

26. The computer program product of claim 21, wherein the first program code portion being configured to receive the content item includes being configured to:
monitor a user preferred online service for a content item publishing event, the content item publishing event indicating that the content item has been published to the user preferred online service; and
receive the content item from the user preferred online service.

27. The computer program product of claim 21, wherein the first program code portion configured to receive the content item includes being configured to receive metadata associated with the content item, and wherein the second program code portion configured to receive the selection of user contact entries includes being configured to determine the selection of user contact entries from the metadata.

28. The computer program product of claim 21, wherein the fourth program code portion being configured to publish the content item includes being configured to publish the content item based on publishing rules.

29. The computer program product of claim 21, wherein the second program code portion configured to receive the selection of user contact entries includes being configured to receive the selection of user contact entries, the user contract entries being imported from a mobile terminal.

30. The computer program product of claim 21, wherein the third program code portion configured to identify the one or more online services associated with the selected user contact entries includes being configured to identify the one or more online services, wherein information describing the online services is stored in association with each user contact entry such that the information is shared.

31. A system comprising:
a content sharing service, the content sharing service having access to one or more user contact entries, the user contact entries being stored with an association to an online service;
a first online service, the first online service including a content item;
a second online service, the second online service being associated with a selected user contact entry; and
a communications network, the communications network providing for communications between the content sharing service, the first online service, and the second online service;
wherein the content sharing service is configured to receive the content item from the first online service and publish the content item on the second online service based on the association between the selected user contact entry and the second online service.

32. The system of claim 31, wherein the second online service is further configured to receive a response item associated with the content item, and provide for transmission of the response item to the content sharing service; and wherein the content sharing service is configured to publish the response item on the first online service in association with the content item.

33. The system of claim 32, wherein the content sharing service is further configured to monitor the second online service for a response item publishing event, the response item publishing event indicating that the response item has been published on the second online service.

34. An apparatus comprising:
means for receiving a content item;
means for receiving a selection of user contact entries;
means for identifying one or more online services associated with the selected user contact entries; and
means for publishing the content item on the one or more identified online services.

35. The apparatus of claim 34, further comprising:
means for receiving a response item from a first identified online service, the response item being associated with the content item; and
means for publishing the response item to a second identified online service in association with the content item.
